(19) United States
(12) Patent Application Publication
(10) Pub. No.: US 2026/0171934 A1
(43) Pub. Date: Jun. 18, 2026

(54) OPTIMIZING ELECTRIC MOTOR SHUT OFF TIMING AND ASSOCIATED METHODS AND SYSTEMS

(71) Applicant: Caterpillar Paving Products Inc., Brooklyn Park, MN (US)

(72) Inventors: Ryan J. Nelson, Maple Grove, MN (US); Mathew J. Hedrington, Ham Lake, MN (US)

(21) Appl. No.: 18/981,157

(22) Filed: Dec. 13, 2024

(51) Int. Cl. H02P 3/02

(52) U.S. Cl. CPC H02P 3/02

(57) ABSTRACT

Systems and methods of optimizing electric motor shut off timing are disclosed. A system comprises a machine including an electric motor, at least one hardware processor, and at least one non-transitory memory. The electric motor is configured to automatically shut off after a first period of time. The at least one non-transitory memory stores instructions which, when executed by the at least one hardware processor, cause the system to determine a pattern of values based on one or more parameters of the machine and/or one or more parameters of the electric motor, generate a second period of time based on the pattern of values, and automatically shut off the electric motor based on the second period of time. In some embodiments, the pattern of values is based on one or more parameters of a user profile associated with an operator of the machine.

### TECHNICAL FIELD

The present application is related to electric motors, and specifically methods and systems of optimizing electric motor shut off timing.

### BACKGROUND

Many machines use electric motors to drive various mechanical operations of the machine. In some circumstances, a machine may perform an operation that requires running the electric motor for a period of time (e.g., to drive a mechanical operation of the machine), followed by a period of inactivity of the motor. Often, the motor is stopped (e.g., automatically via a control circuit) following this period of inactivity. This results in the motor having to be restarted when, for example, the machine needs to perform a subsequent operation involving the motor, which can cause undesirable delays in operation of the machine and may cause operator dissatisfaction.

Patent US10082771B2 discloses a machine learning apparatus configured to learn an operating command to an electric motor. However, the patent does not disclose modifying shut off timing of an electric motor based on likelihood of motor activity and/or operator action.

### SUMMARY

The disclosed technology provides methods and systems for optimizing electric motor shut off timing. In some embodiments, a system of optimizing electric motor shut off timing comprises a machine including an electric motor, at least one hardware processor, and at least one non-transitory memory. The electric motor is configured to automatically shut off after a first period of time. The at least one non-transitory memory stores instructions which, when executed by the at least one hardware processor, cause the system to: (i) determine a pattern of values based on one or more parameters of the machine and/or one or more parameters of the electric motor, where the pattern of values is indicative of an action of the electric motor and/or machine, (ii) generate a second period of time based on the pattern of values, and (iii) automatically shut off the electric motor based on the second period of time.

In some embodiments, a method of optimizing electric motor shut off timing comprises: (i) identifying a period of time associated with automatically shutting off an electric motor of a machine, (ii) determining one or more parameters of the machine, one or more parameters of the electric motor, and/or one or more parameters of a user profile associated with an operator of the machine, (iii) determining a pattern of values based on the one or more parameters, where the pattern of values is indicative of an action of the electric motor and/or machine, (iv) modifying the period of time based on the pattern of values, and (iv) automatically shutting off the electric motor based on the modified period of time.

In some embodiments, a non-transitory, computer-readable storage medium comprises instructions thereon, which, when executed by at least one data processor of a system, cause the system to: (i) determine a pattern of values based on one or more parameters of a machine and/or one or more parameters of an electric motor of the machine, where the electric motor is configured to automatically shut off after a period of time, and where the pattern of values is indicative of an action of the electric motor and/or machine, (ii) modify the period of time based on the pattern of values, and (iii) automatically shut off the electric motor based on the modified period of time.

### BRIEF DESCRIPTION OF THE DRAWINGS

FIG. 1 is a block diagram illustrating a system configured in accordance with some embodiments of the present technology.

FIG. 2 is a flow diagram illustrating a method of optimizing electric motor shut off timing in accordance with some embodiments of the present technology.

FIG. 3 is a flow diagram illustrating a method of optimizing electric motor shut off timing in accordance with some embodiments of the present technology.

FIG. 4 is a flow diagram of a method of generating a shut off delay time in accordance with some embodiments of the present technology.

FIG. 5 is a block diagram illustrating a machine learning (ML) system in accordance with some embodiments of the present technology.

FIG. 6 is a block diagram illustrating an overview of an environment in which the disclosed technology can operate in accordance with some embodiments of the present technology.

FIG. 7 is a block diagram illustrating a computer system in accordance with some embodiments of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology provides methods and systems for optimizing electric motor shut off timing. Industrial machinery and/or vehicles, such as many cranes, excavators, pavers, compactors, and the like, often use electric motors to perform certain mechanical operations. When a machine does not need operation of the electric motor (e.g., the machine is not performing a mechanical operation driven by the motor), the motor can be configured (e.g., via control logic) to shut off after a period of time (also referred to as a “delay time” or “shut off delay”) to conserve energy and/or mitigate energy waste, and to mitigate motor wear. However, in some situations, this can give rise to operational delays and operator dissatisfaction since the motor needs to be restarted for subsequent use.

The disclosed technology addresses these and other issues by providing a system of optimizing electric motor shut off timing. For purposes of this application, the term “optimizing” and/or “optimize” refer to determining a shut off time of an electric motor such that energy waste and motor wear associated with running the motor are reduced while also minimizing operational delays and/or operator dissatisfaction associated with having to restart the electric motor after shut off. That is, the disclosed technology is configured to determine a shut off timing that balances (i) running the motor long enough to allow for immediate or near-immediate use when desired by an operator and/or as needed by the machine, and (ii) shutting off the motor to mitigate energy waste and/or motor wear.

In some embodiments, the system comprises a machine (e.g., an asphalt paver, a compactor, or other industrial machine) including an electric motor, at least one hardware processor, and at least one non-transitory memory. The electric motor is configured to automatically shut off after a first period of time. The non-transitory memory stores instructions, which, when executed by the hardware processor, causes the system to determine (e.g., calculate, compute, etc.) a pattern of values indicative of an anticipated and/or imminent/near-imminent action (i.e., operation) of the electric motor and/or machine, generate a second period of time based on the pattern of values, and automatically shut off the electric motor based on the second period of time. As discussed further herein, the pattern of values can be based on recent behaviour and/or history of operating the machine.

In some embodiments, the pattern of values is based on one or more parameters of the machine. For example, in some embodiments, the one or more parameters of the machine can include an action of the machine, status of the machine, input from an operator, movement of the machine, position of the machine, location of the machine, start up of the machine, shut off of the machine, run time of the machine, and/or tasks assigned the machine.

In some embodiments, the pattern of values is based on one or more parameters of the electric motor. For example, in some embodiments, the one or more parameters of the electric motor can include run time of the electric motor, an action of the electric motor, status of the electric motor, and/or input from the operator.

In some embodiments, the pattern of values is based on one or more parameters of a user profile associated with an operator of the machine. For example, in some embodiments, the one or more parameters of the user profile can include time since the operator previously shut off the electric motor, time since the operator previously started the electric motor, experience of the operator, certifications and/or qualifications of the operator, frequency of start up and/or shut off of the electric motor by the operator, and/or tasks assigned the operator.

In some embodiments, the pattern of values includes time since previous shut off of the electric motor, time since previous start up of the electric motor, previous run time of the electric motor, frequency of start up and/or shut off of the electric motor, type of action of the electric motor, type of action of the machine, time since previous shut off of the machine, time since previous start up of the machine, previous run time of the machine, frequency of start up and/or shut off of the machine, likelihood of an action of the machine, and/or likelihood of an action of the electric motor.

In some embodiments, the pattern of values is determined using at least one machine-learning algorithm. For example, the pattern of values can be determined via at least one machine-learning algorithm trained on at least one dataset associated with previously determined patterns of values based on one or more parameters of the machine, one or more parameters of the electric motor, and/or one or more parameters of the user profile. In some embodiments, the pattern of values is determined using one or more lookup tables.

In some embodiments, the system is configured to determine the likelihood of one or more actions of the electric motor (e.g., pressurizing a hydraulic system, raising and/or lowering a component of the machine, increasing/decreasing motor speed, and the like) based on the pattern of values. In such embodiments, the system can be configured to generate the second period of time based on the likelihood of the one or more actions of the electric motor.

In some embodiments, the system is configured to determine the likelihood of one or more actions of the machine (e.g., moving and/or repositioning one or more components of the machine, and the like) based on the pattern of values. For example, the system can be configured to determine the likelihood of actuating a material feed system and can generate the second period of time based on the likelihood of actuation.

In some embodiments, the system is configured to correlate one or more parameters (e.g., a first set of parameters) of the machine and/or electric motor with a first action of the machine and/or electric motor, correlate one or more parameters (e.g., a second set of parameters) with a second action of the electric motor and/or machine, and determine a pattern of values and/or actions based on the first and second sets of parameters that is indicative of an anticipated action of the electric motor and/or the machine (e.g., the first and/or second action). In such embodiments, the period of time can be modified based on the determined pattern of values and/or actions.

In some embodiments, the system is configured to determine multiple patterns of values and can generate one or more periods of time (e.g., the second period of time, a third period of time, a fourth period of time, etc.) based on one or more of the multiple patterns of values. For example, the system can be configured to determine a first pattern of values corresponding to a first action of the electric motor and/or a first action of the machine (e.g., driving and/or repositioning the machine) and to generate the second period of time based on the first pattern of values. The system can additionally determine a second pattern of values corresponding to a second action of the electric motor and/or a second action of the machine (e.g., actuating a hopper) and generate a third period of time based on the second pattern of values. The system can be configured to then shut off the electric motor automatically after the second period of time or the third period of time.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

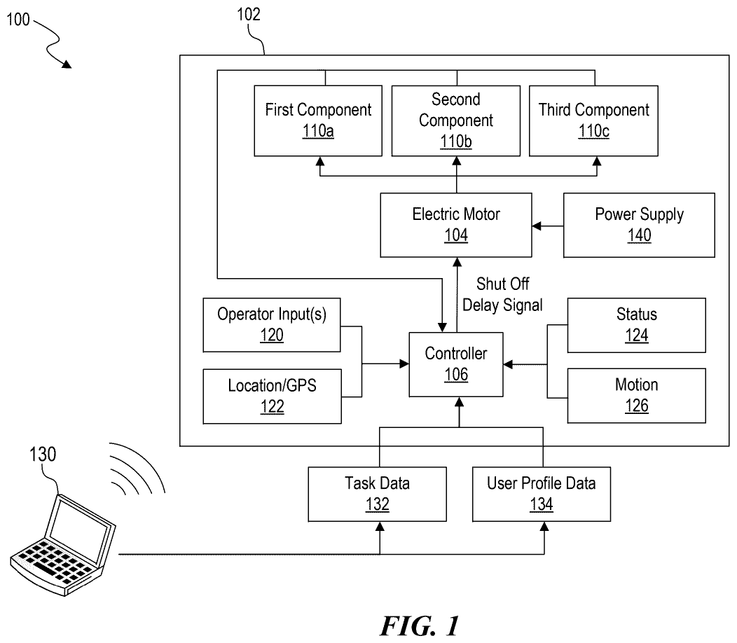

FIG. 1 is a block diagram illustrating a system 100 configured in accordance with some embodiments of the present technology. In the present embodiment, the system 100 is comprised of a machine 102 including an electric motor 104 and a controller 106, where the electric motor 104 can be configured to drive one or more components 110a-c of the machine 102. For example, the machine 102 can be an electrified (i.e., with a battery or other power supply 140) industrial machine and/or vehicle, such as an asphalt paver, compactor, excavator, crane, etc., and the electric motor 104 can be configured to drive mechanical operations of one or more components, such as a material feed function, auger, hopper, etc. of the industrial machine and/or vehicle.

The electric motor 104 is configured to automatically shut off after a period of time (e.g., a shut off delay time). In some embodiments, the period of time corresponds to a period of inactivity of the electric motor 104 and/or machine 102. For example, the electric motor 104 can be configured to automatically shut off after 3 minutes without receiving a signal corresponding to an action of the electric motor (e.g., actuating a hopper, driving an auger, and/or operating a material feed system). In some embodiments, the period of time is not less than: 0 seconds (e.g., immediate shut off), 5 seconds, 10 seconds, 15 seconds, 30 seconds, and/or 45 seconds. In some embodiments, the period of time can be a range such as between about 0-5 seconds, 5-15 seconds, 15-45 seconds, and/or 45-60 seconds. In some embodiments, the period of time is not less than: 0 minutes (e.g., immediate shut off), 1 minute, 3 minutes, and/or 5 minutes. In some embodiments, the period of time can be between about 0-1 minute, 1-3 minutes, and/or 3-5 minutes.

The controller 106 is configured to control (e.g., increase, decrease, modify, and/or maintain) the amount/length of time of the period of time. In some embodiments, the controller 106 is configured (e.g., via control logic) to anticipate an action of the electric motor 104 and/or machine 102, and to adjust the period of time based on the anticipated action. For example, if the machine 102 is frequently driving and stopping in relatively short succession, the controller 106 can modify (e.g., increase) the period of time so that the electric motor 104 runs for a longer period of time after each stop of the machine 102, in anticipation of subsequent driving. This avoids unnecessarily having to restart the motor 104 an undesirable number of times (e.g., after each intermittent stop) over the course of a particular job or portion of a job.

As another example, an electrified asphalt paver may have to intermittently pause a first operation (e.g., paving operations) to coordinate with other industrial machines (e.g., trucks delivering asphalt material). During these pauses, the electric motor 104 may automatically shut off (e.g., to reduce energy waste/consumption and/or mitigate motor wear). However, the paver may regularly initiate a second operation requiring electric motor 104 action (e.g., actuating a material feed function) during the intermittent pauses of the first operation, which may be indicated by a parameter of the machine (e.g., the material feed height is within a pre-determined range). The controller 106 can identify this pattern of electric motor 104 and/or machine 102 action, associate the pattern with the first and second operations, and modify (e.g., increase) the period of time based on the pattern so that the motor 104 does not unnecessarily shut off following the pause of the first operation. That is, the motor 104 can remain running for an extended period of time to support the anticipated second operation. Of course, if the second operation does not occur (e.g., paving operations are paused and the material feed height is within the pre-determined range, but the material feed function is not actuated), the modified shut off delay time will elapse and the electric motor 104 will shut off.

To anticipate actions of the electric motor 104 and/or machine 102, the controller 106 is configured to identify and/or determine one or more patterns of values (i.e., inputs) associated with actions of the electric motor 104 and/or machine 102. In some embodiments, these patterns of values are based on one or more parameters of the machine 102, one or more parameters of the electric motor 104, one or more parameters of a user profile 134 of an operator (or crew/team) of the machine 102 (indicated as user profile data 134 in FIG. 1), and/or one or more parameters of a task/job/assignment 132 (indicated as task data 132 in FIG. 1). In some embodiments, the controller 106 correlates the one or more parameters of the machine 102, electric motor 104, task/job/assignment 132, and/or user profile 134 with a particular action of the electric motor 104 and/or machine 102. For example, based on historical and contemporaneous inputs associated with (1) operator input 120 (e.g., position of a drive lever or switch) to the machine 102, (2) status of the motor 104, (3) the job 132 assigned to the machine 102, and/or (4) the user profile 134 of the operator of the machine 102, the controller 106 can determine a pattern of values correlated to an imminent or near-imminent action of the machine 102 and/or motor 104, such as actuating a material feed function. The shut off delay time is then modified in response to the imminent or near imminent action (e.g., the shut off delay time is increased) to ensure the motor 104 is still running when the action is expected to occur.

In some embodiments, the identified and/or determined patterns of values include: time since previous shut off of the electric motor, time since previous start up of the electric motor, previous run time of the electric motor, frequency of start up and/or shut off of the electric motor, type of action of the electric motor, type of action of the machine, time since previous shut off of the machine, time since previous start up of the machine, previous run time of the machine, frequency of start up and/or shut off of the machine, likelihood of an action of the machine, and/or likelihood of an action of the electric motor

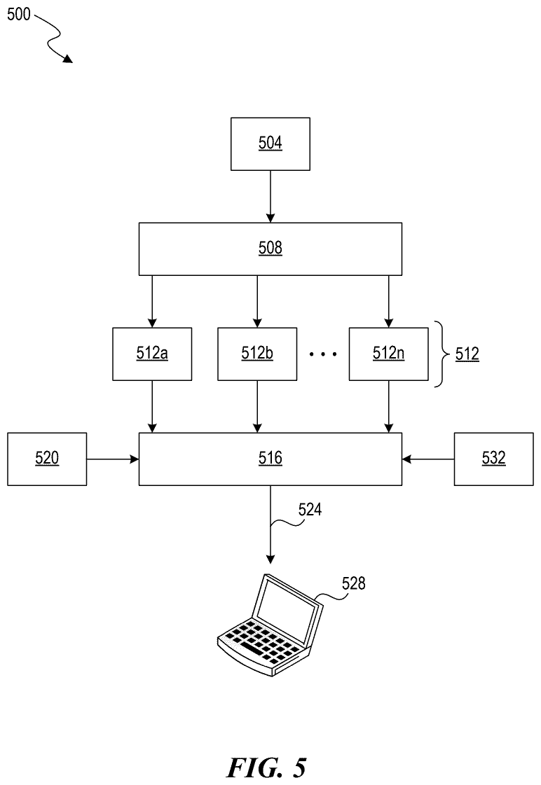

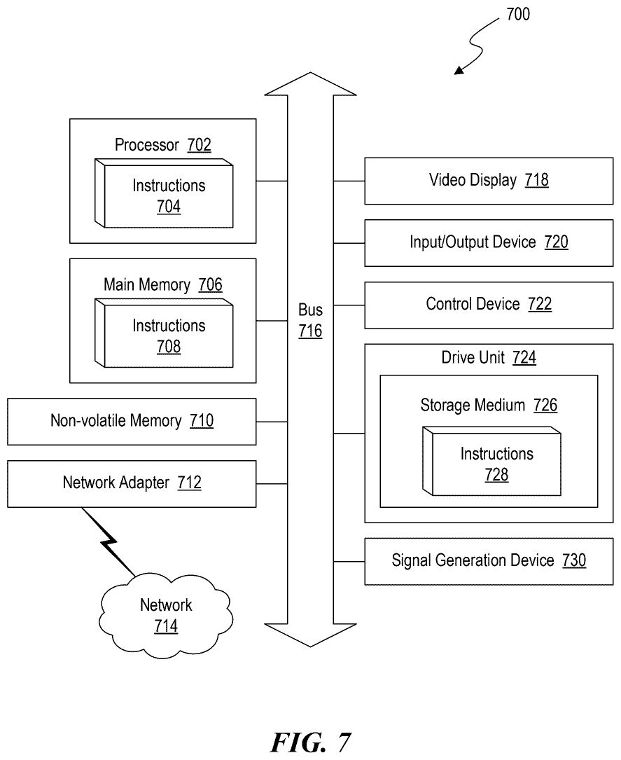

In some embodiments, a computer 130 (e.g., the computer device 528 of FIG. 5 and/or the computer system 700 of FIG. 7) is configured to provide external data to the machine 102. For example, external data can include inputs associated with industrial vehicle/truck routing and associated telematic data. In some embodiments, the external data can include parameters of the machine 102, parameters of the electric motor 104, parameters of the task data 132, and/or parameters of the user profile data 134. In some embodiments, one or more of the parameters of the machine 102, electric motor 104, task data 132, and/or user profile data 134 are provided and/or determined directly from components (e.g., first component 110a, second component 110b, third component 110c) and/or inputs (e.g., operator input 120, location/GPS data 122, operating status 124, motion 126, and/or other sensors) of the machine 102.

In some embodiments, the one or more parameters of the machine 102 include: an action of the machine 102, status 124 (e.g., the machine is in a start up condition, shut down condition, neutral condition, etc.), operator input 120, movement/motion 126, position/location 122, run time of the machine, and/or tasks assigned the machine. For example, the controller 106 can determine a pattern of values based on historical and contemporaneous inputs corresponding to a height of a first component 110a, such as a material feed component, a speed of a second component 110b, such as an auger, a weight load condition of a third component 110c, such as a loading bin (e.g., of a material transfer vehicle), operator input 120, such as a position of a drive lever, a status 124 of the machine 102, such as idling, and inputs associated with one or more supporting vehicles, such as location/position and/or payload. In some embodiments, the one or more machine parameters of the machine 102 can include inputs from one or more light detection/perception systems (e.g., cameras, radar systems, LiDAR systems, etc.) and the like).

In some embodiments, the one or more parameters of the electric motor 104 include: run time, an action of the electric motor 104, status of the electric motor 104, and/or input from the operator to the motor 104. For example, the controller 106 can determine a pattern of values based on historical and contemporaneous inputs corresponding to a run time of the motor 104, such as 10 seconds, followed by a status of the motor 104, such as idling.

In some embodiments, the one or more parameters of the user profile data 134 includes: time since an operator previously shut off the electric motor 104, time since an operator previously started the electric motor 104, experience of an operator, certifications and/or qualifications of an operator, frequency of start up and/or shut off of the electric motor 104 by an operator, and/or tasks assigned an operator. For example, the controller 106 can determine a pattern of values based on historical and contemporaneous inputs corresponding to particular operating characteristics of a user associated with the user profile data 134, such as the frequency with which the user prefers to start and/or start the motor 104 and/or the machine 102.

In some embodiments, the one or more parameters of the task data 132 include: a task type, task length, materials associated with the task, crew size associated with the task, anticipated follow-on tasks, and/or task history.

In some embodiments, the pattern of values is based on the type of machine 102 (e.g., asphalt paver, crane, etc.). In some embodiments, the pattern of values is based on additional external inputs (not pictured). For example, the period of time for an electric motor 104 of an electrified asphalt compactor can be adjusted based on compaction mapping data provided to the compactor.

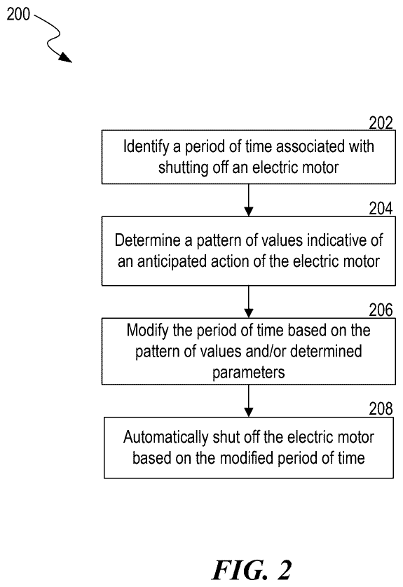

FIG. 2 is a flow diagram illustrating a method 200 of optimizing electric motor shut off timing in accordance with some embodiments of the present technology. In some embodiments, the method 200 includes features and/or components generally similar/identical to the features and/or components of system 100 of FIG. 1.

At block 202, a period of time associated with shutting off an electric motor (i.e., a shut off delay time) of a machine is identified. In some embodiments, the period of time corresponds to a period of inactivity of the electric motor and/or machine. For example, the electric motor can be configured to automatically shut off after 3 minutes without receiving a signal corresponding to an action of the electric motor. In some embodiments, the period of time is not less than: 0 seconds (e.g., immediate shut off), 5 seconds, 10 seconds, 15 seconds, 30 seconds, and/or 45 seconds. In some embodiments, the period of time can be a range such as between about 0-5 seconds, 5-15 seconds, 15-45 seconds, and/or 45-60 seconds. In some embodiments, the period of time is not less than: 0 minutes (e.g., immediate shut off), 1 minute, 3 minutes, and/or 5 minutes. In some embodiments, the period of time can be between about 0-1 minute, 1-3 minutes, and/or 3-5 minutes.

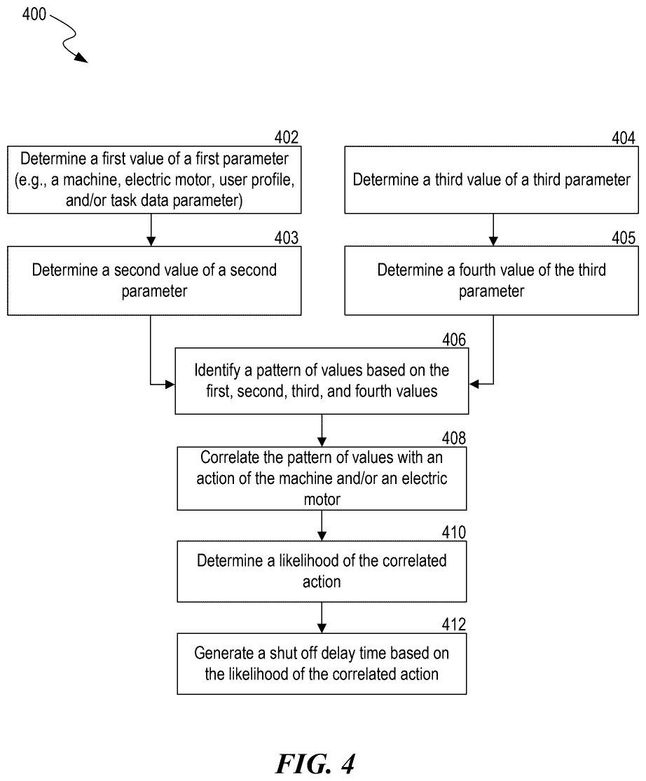

At block 204, a pattern of values indicative of an anticipated action of the electric motor is determined (e.g., calculated, computed, etc.). In some embodiments, the pattern of values is determined based on historical and contemporaneous inputs corresponding to one or more parameters of one or more parameters of the machine, one or more parameters of the electric motor, one or more parameters of a user profile associated with an operator of the machine, and/or one or more parameters of a task/job/assignment of the machine (discussed further in FIG. 4).

At block 206, the period of time associated with shutting off the electric motor is modified (e.g., increased or decreased) based on the determined pattern of values. In some embodiments, the period of time is modified based at least in part on the determined parameters of the user profile, electric motor, machine, and/or task. That is, inputs correlated to one or more of the parameters of the user profile, electric motor, machine, and/or task are used to modify the period of time separately from the pattern of values. For example, a pattern of values based on historical and contemporaneous inputs for material feed height of the machine and drive lever position of the machine can result in an increased shut off delay time (e.g., from 1 minute to 3 minutes). However, the type of task can be used to further adjust or “tune” the shut off delay time (e.g., by decreasing the modified time from 3 minutes to 2 minutes). At block 208, the electric motor is automatically shut off based on the modified period of time.

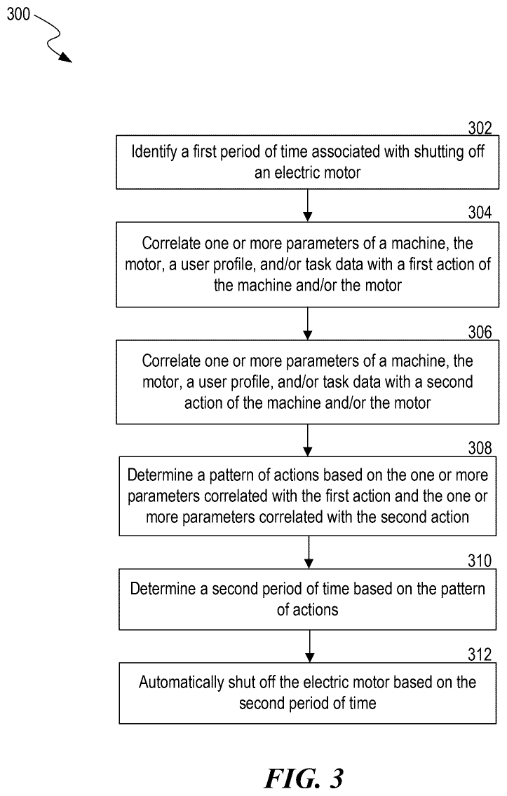

FIG. 3 is a flow diagram illustrating a method 300 of optimizing electric motor shut off timing in accordance with some embodiments of the present technology. In some embodiments, the method 300 includes features and/or components generally similar/identical to the features and/or components of system 100 of FIG. 1.

At block 302, a first period of time associated with shutting off an electric motor (e.g., a shut off delay time) of a machine is identified. For example, the electric motor can be configured to automatically shut off after 3 minutes without receiving a signal corresponding to an action of the electric motor.

At block 304, one or more parameters of the machine, one or more parameters of the electric motor, one or more parameters of a user profile, and/or one or more parameters of task data (in some embodiments, collectively referred to as a first set of parameters) are correlated with a first action of the machine and/or motor. For example, for an asphalt paver, a first position of a drive lever (e.g., a parameter of the machine), a first material feed height (e.g., a parameter of the machine), a previous run time of the electric motor (e.g., a parameter of the electric motor), a certification of the operator of the machine (e.g., a parameter of the user profile), and a particular paving assignment (e.g., a parameter of the task data) can be correlated with a driving operation (e.g., a first action).

At block 306, one or more parameters of the machine, one or more parameters of the electric motor, one or more parameters of a user profile, and/or one or more parameters of task data (in some embodiments, collectively referred to as a second set of parameters) are correlated with a second action of the machine and/or motor. For example, continuing with the asphalt paver example above, a second position of the drive lever (e.g., a parameter of the machine), a second material feed height (e.g., a parameter of the machine), a current running operation of the electric motor (e.g., a parameter of the electric motor), a preferred operating characteristic of the operator of the machine (e.g., a parameter of the user profile), and other industrial vehicles assigned to the task (e.g., a parameter of the task data) can be correlated with material feed system actuation (e.g., a second action).

At block 308, a pattern of actions is determined (e.g., computed, calculated, etc.) based on the one or more parameters correlated with the first action and the one or more parameters correlated with the second action. For example, continuing with the asphalt paver example above, the pattern of values can be determined based on a frequency and/or timing of the parameters correlated with the driving operation occurring in relation to the frequency and/or timing of the parameters correlated with the material feed system actuation.

At block 310, a second period of time based on the pattern of values is determined. For example, based on the timing of the material feed system actuation parameters in relation to the driving operation parameters (i.e., the pattern of values), a second shut off delay time can be determined that is longer than the first shut off delay time, in anticipation that material feed system actuation and/or driving operations are imminent/near imminent. In some embodiments, the second period of time is the same as the first period of time. At block 312, the electric motor is automatically shut off based on the second period of time.

FIG. 4 is a flow diagram of a method 400 of generating a shut off delay time in accordance with some embodiments of the present technology. In some embodiments, the method 400 includes features and/or components generally similar/identical to the features and/or components of system 100 of FIG. 1.

At block 402, a first value of a first parameter is determined (e.g., by controller 106 of FIG. 1). In some embodiments, the first parameter is a first parameter of a machine, electric motor, user profile, and/or task data (described more fully with regard to FIG. 1). For example, the first parameter can be a drive lever position of a machine, and the first value can be a “stopped” or “idle” value. At block 403, a second value of a second parameter is determined. The second parameter can be of the same or different type of parameter as the first parameter (e.g., the first parameter can be a parameter of the machine, and the second parameter can be a different parameter of the machine, or a parameter of the electric motor, user profile, and/or task data). For example, the second parameter can be a material feed height, and the second value can be a value of “low” or “high.”

At block 404, a third value of a third parameter is determined. The third parameter can be of the same or different type as the first and/or second parameters. For example, the third parameter can be a first historical/previous run time of the electric motor. At block 405, a fourth value of the third parameter is determined. For example, the fourth value can be a second historical/previous run time of the electric motor, where the second historical/previous run time of the electric motor is closer in time (i.e., more contemporaneous) relative to an active job of the machine and/or electric motor.

At block 406, a pattern of values is identified (e.g., by controller 106 of FIG. 1) based on the first, second, third, and fourth values. For example, for an asphalt paver, the controller 106 can identify repeated sequences of a drive lever position being in a “stopped” position (i.e., the first value), a material feed height being “low” (i.e., the second value), and an electric motor running for a first run time (i.e., the third value) followed by the motor running for a second run time (i.e., the fourth value). At block 408, the pattern of values is correlated with an action of a machine and/or electric motor. For example, the repeated sequence discussed herein can be correlated with actuating a material feed function. In some embodiments, the pattern of values is identified based on information/data stored as a lookup table. For example, controller 106 can compare the types of parameters (e.g., the first, second, and third parameters associated with a first machine parameter, second machine parameter, and third machine parameter, respectively) and the values of the first, second, third, and fourth values to a lookup table to identify the pattern of values.

At block 410, a likelihood of the correlated action is determined (e.g., by the controller 106). In some embodiments, the likelihood of the correlated action is based at least in part based on the pattern of values. For example, the pattern of values can be compared to previously identified patterns of values (e.g., via a lookup table or a machine learning system (e.g., the ML system 500 of FIG. 5), and the likelihood can be based on the similarity between the patterns of values.

At block 412, a shut off delay time of an electric motor is generated based on the likelihood of the correlated action. In some embodiments, the shut off delay time is based on the likelihood of the correlated action meeting or exceeding a threshold likelihood (e.g., meeting or exceeding a 50%, 40%, 30%, etc., chance of occurring and/or being initiated by an operator). In some embodiments, the generated shut off delay time is proportional to the determined likelihood. For example, where the determined likelihood is 50%, the shut off delay time can be increased by 50%. As another example, where the determined likelihood is 40%, the shut off delay time can be increased by 10%.

In some embodiments, the generated shut off delay time is a modification of an existing and/or prior shut off delay time of the electric motor. For example, the generated shut off delay time can include increasing or decreasing the existing and/or prior shut off delay time of the electric motor.

FIG. 5 is a block diagram illustrating a ML system 500, in accordance with one or more embodiments. The ML system 500 is implemented using components of the computer system 700 illustrated and described in more detail with reference to FIG. 7. Different embodiments of the ML system 500 include different and/or additional components and are connected in different ways. The ML system 500 is sometimes referred to as a ML module.

The ML system 500 includes a feature extraction module 508 implemented using components of the computer system 700 illustrated and described in more detail with reference to FIG. 7. In some embodiments, the feature extraction module 508 extracts a feature vector 512 from input data 504. For example, the input data 504 includes input data from a machine (e.g., machine 102 of FIG. 1), input data from an electric motor of the machine (e.g., electric motor 104), input data from a user profile of an operator of the machine (e.g., user profile data 134), and/or input data from a task/job/assignment of the machine (e.g., task data 132). In some embodiments, the input data 504 includes previously established correlations between one or more actions/operations of a machine and/or electric motor, and the various input data 504 (e.g., from a machine, electric motor, user profile, and/or task data).

For example, input data 504 from the machine can include an action of the machine, status of the machine, input from an operator, movement of the machine, position of the machine, location of the machine, start up of the machine, shut off of the machine, run time of the machine, and/or tasks assigned the machine. Input data 504 from the electric motor can include run time of the electric motor, an action of the electric motor, status of the electric motor, and/or input from the operator. Input data 504 from the user profile can include time since the operator previously shut off the electric motor, time since the operator previously started the electric motor, experience of the operator, certifications and/or qualifications of the operator, frequency of start up and/or shut off of the electric motor by the operator, and/or tasks assigned the operator. Input data from the task of the machine can include a task type, task length, materials associated with the task, crew size associated with the task, anticipated follow-on tasks, and/or task history.

The feature vector 512 includes features 512a, 512b, . . . , 512n. The feature extraction module 508 reduces the redundancy in the input data 504, for example, repetitive data values, to transform the input data 504 into the reduced set of features 512, for example, features 512a, 512b, . . . , 512n. The feature vector 512 contains the relevant information from the input data 504, such that events or data value thresholds of interest are identified by the ML model 516 by using a reduced representation. In some embodiments, the following dimensionality reduction techniques are used by the feature extraction module 508: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 516 performs deep learning (also known as deep structured learning or hierarchical learning) directly on the input data 504 to learn data representations, as opposed to using task-specific algorithms. In deep learning, no explicit feature extraction is performed; the features 512 are implicitly extracted by the ML system 500. For example, the ML model 516 uses a cascade of multiple layers of nonlinear processing units for implicit feature extraction and transformation. Each successive layer uses the output from the previous layer as input. The ML model 516 thus learns in supervised (e.g., classification) and/or unsupervised (e.g., pattern analysis) modes. The ML model 516 learns multiple levels of representations that correspond to different levels of abstraction, wherein the different levels form a hierarchy of concepts. The multiple levels of representation configure the ML model 516 to differentiate features of interest from background features.

In alternative embodiments, the ML model 516, for example, in the form of a CNN generates the output 524, without the need for feature extraction, directly from the input data 504. The output 524 is provided to the computer device 528. The computer device 528 is a server, computer, tablet, smartphone, etc., implemented using components of the computer system 700 illustrated and described in more detail with reference to FIG. 7. In some embodiments, the steps performed by the ML system 500 are stored in memory on the computer device 528 for execution. In other embodiments, the output 524 is displayed on electronic displays of the computer device 528.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 516 is a CNN that includes both convolutional layers and max pooling layers. For example, the architecture of the ML model 516 is “fully convolutional,” which means that variable sized sensor data vectors are fed into it. For convolutional layers, the ML model 516 specifies a kernel size, a stride of the convolution, and an amount of zero padding applied to the input of that layer. For the pooling layers, the model 516 specifies the kernel size and stride of the pooling.

In some embodiments, the ML system 500 trains the ML model 516, based on the training data 520, to correlate the feature vector 512 to expected outputs in the training data 520. As part of the training of the ML model 516, the ML system 500 forms a training set of features and training labels by identifying a positive training set of features that have been determined to have a desired property in question, and, in some embodiments, forms a negative training set of features that lack the property in question.

The ML system 500 applies ML techniques to train the ML model 516, that when applied to the feature vector 512, outputs indications of whether the feature vector 512 has an associated desired property or properties, such as a probability that the feature vector 512 has a particular Boolean property, or an estimated value of a scalar property. In embodiments, the ML system 500 further applies dimensionality reduction (e.g., via linear discriminant analysis (LDA), PCA, or the like) to reduce the amount of data in the feature vector 512 to a smaller, more representative set of data.

In embodiments, the ML system 500 uses supervised ML to train the ML model 516, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some embodiments, a validation set 532 is formed of additional features, other than those in the training data 520, which have already been determined to have or to lack the property in question. The ML system 500 applies the trained ML model 516 to the features of the validation set 532 to quantify the accuracy of the ML model 516. Common metrics applied in accuracy measurement include Precision and Recall, where Precision refers to a number of results the ML model 516 correctly predicted out of the total it predicted, and Recall is a number of results the ML model 516 correctly predicted out of the total number of features that had the desired property in question. In some embodiments, the ML system 500 iteratively re-trains the ML model 516 until the occurrence of a stopping condition, such as the accuracy measurement indication that the ML model 516 is sufficiently accurate, or a number of training rounds having taken place. In embodiments, the validation set 532 includes data corresponding to confirmed mechanical properties and/or weightings/constants and combinations thereof. This allows the detected values to be validated using the validation set 532. The validation set 532 is generated based on the analysis to be performed.

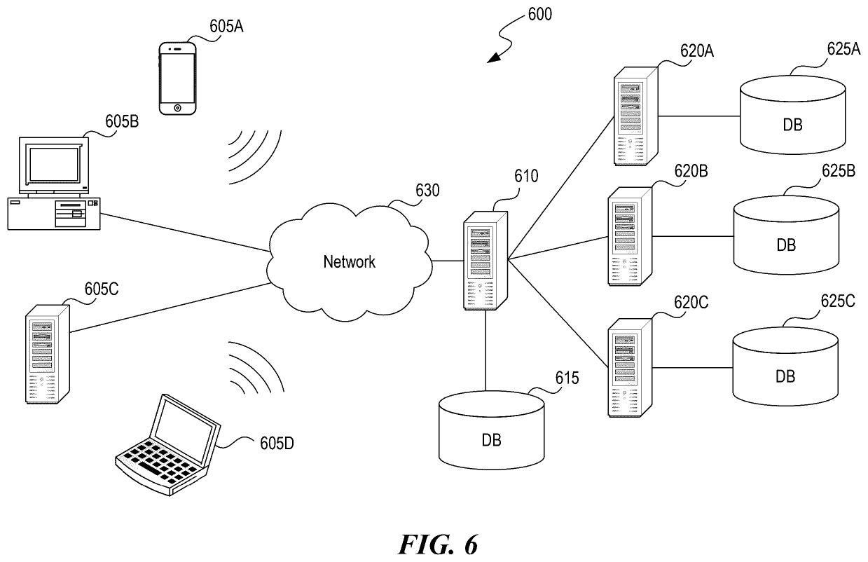

FIG. 6 is a block diagram illustrating an overview of an environment 600 in which the disclosed technology can operate, in accordance with some embodiments of the present technology. Environment 600 can include one or more client computing devices 605A-D, examples of which can include computer system 700. Client computing devices 605 can operate in a networked environment using logical connections through network 630 to one or more remote computers, such as a server computing device 610.

In some implementations, server 610 can be an edge server which receives client requests and coordinates fulfillment of those requests through other servers, such as servers 620A-C. Server computing devices 610 and 620 can comprise computing systems, such as system 700. Though each server computing device 610 and 620 is displayed logically as a single server, server computing devices can each be a distributed computing environment encompassing multiple computing devices located at the same or at geographically disparate physical locations. In some implementations, each server 620 corresponds to a group of servers.

Client computing devices 605 and server computing devices 610 and 620 can each act as a server or client to other server/client devices. Server 610 can connect to a database 615. Servers 620A-C can each connect to a corresponding database 625A-C. As discussed above, each server 620 can correspond to a group of servers, and each of these servers can share a database or can have their own database. Databases 615 and 625 can warehouse (e.g., store) information such as one or more parameters of a machine (e.g., machine 102 of FIG. 1), one or more parameters of an electric motor (e.g., electric motor 104), one or more parameters of a user profile associated with an operator of the machine (e.g., user profile data 134), and/or one or more parameters of a task/job/assignment of the machine (e.g., task data 132). In some embodiments, the databases 615 and 625 can warehouse previously established correlations between one or more actions/operations of a machine and/or electric motor, and the various parameters from a machine, electric motor, user profile, and/or task data.

For example, one or more parameters of the machine can include an action of the machine, status of the machine, input from an operator, movement of the machine, position of the machine, location of the machine, start up of the machine, shut off of the machine, run time of the machine, and/or tasks assigned the machine. One or more parameters of the electric motor can include run time of the electric motor, an action of the electric motor, status of the electric motor, and/or input from the operator. One or more parameters of the user profile can include time since the operator previously shut off the electric motor, time since the operator previously started the electric motor, experience of the operator, certifications and/or qualifications of the operator, frequency of start up and/or shut off of the electric motor by the operator, and/or tasks assigned the operator. One or more parameters of the task of the machine can include a task type, task length, materials associated with the task, crew size associated with the task, anticipated follow-on tasks, and/or task history.

Though databases 615 and 625 are displayed logically as single units, databases 615 and 625 can each be a distributed computing environment encompassing multiple computing devices, can be located within their corresponding server, or can be located at the same or at geographically disparate physical locations.

Network 630 can be a local area network (LAN) or a wide area network (WAN), but can also be other wired or wireless networks. Network 630 may be the Internet or some other public or private network. Client computing devices 605 can be connected to network 630 through a network interface, such as by wired or wireless communication. While the connections between server 610 and servers 620 are shown as separate connections, these connections can be any kind of local, wide area, wired, or wireless network, including network 630 or a separate public or private network.

FIG. 7 is a block diagram illustrating a computer system 700, in accordance with one or more embodiments. Components of the computer system 700 are used to implement one or more portions of methods 200, 300, and/or 400 of FIGS. 2-4, respectively, and/or perform analysis and calculations described throughout this document. In some embodiments, components of the computer system 700 are used to implement the ML system 500 illustrated and described in more detail with reference to FIG. 5. At least some operations described herein are implemented on the computer system 700.

The computer system 700 includes one or more central processing units (“processors”) 702, main memory 706, non-volatile memory 710, network adapters 712 (e.g., network interface), video displays 718, input/output devices 720, control devices 722 (e.g., keyboard and pointing devices), drive units 724 including a storage medium 726, and a signal generation device 720 that are communicatively connected to a bus 716. The bus 716 is illustrated as an abstraction that represents one or more physical buses and/or point-to-point connections that are connected by appropriate bridges, adapters, or controllers. In embodiments, the bus 716, includes a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

In embodiments, the computer system 700 shares a similar computer processor architecture as that of a desktop computer, tablet computer, personal digital assistant (PDA), mobile phone, game console, music player, wearable electronic device (e.g., a watch), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 700.

While the main memory 706, non-volatile memory 710, and storage medium 726 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 728. The term “machine-readable medium” and “storage medium” shall also be taken to include any medium that is capable of storing, encoding, or carrying a set of instructions for execution by the computer system 700.

In general, the routines executed to implement the embodiments of the disclosure are implemented as part of an operating system or a specific application, component, program, object, module, or sequence of instructions (collectively referred to as “computer programs”). The computer programs typically include one or more instructions (e.g., instructions 704, 708, 728) set at various times in various memory and storage devices in a computer device. When read and executed by the one or more processors 702, the instruction(s) cause the computer system 700 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 710, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 712 enables the computer system 700 to mediate data in a network 714 with an entity that is external to the computer system 700 through any communication protocol supported by the computer system 700 and the external entity. In embodiments, the network adapter 712 includes a network adapter card, a wireless network interface card, a router, an access point, a wireless router, a switch, a multilayer switch, a protocol converter, a gateway, a bridge, a bridge router, a hub, a digital media receiver, and/or a repeater.

In embodiments, the network adapter 712 includes a firewall that governs and/or manages permission to access proxy data in a computer network and tracks varying levels of trust between different machines and/or applications. In embodiments, the firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall additionally manages and/or has access to an access control list that details permissions including the access and operation rights of an object by an individual, a machine, and/or an application, and the circumstances under which the permission rights stand.

In embodiments, the functions performed in the processes and methods are implemented in differing order. Furthermore, the outlined steps and operations are only provided as examples. For example, some of the steps and operations are optional, combined into fewer steps and operations, or expanded into additional steps and operations without detracting from the essence of the disclosed embodiments.

In embodiments, the techniques introduced here are implemented by programmable circuitry (e.g., one or more microprocessors), software and/or firmware, special-purpose hardwired (i.e., non-programmable) circuitry, or a combination of such forms. In embodiments, special-purpose circuitry is in the form of one or more application-specific integrated circuits (ASICs), programmable logic devices (PLDs), field-programmable gate arrays (FPGAs), etc.

### INDUSTRIAL APPLICABILITY

The disclosed systems and methods can be implemented in a machine that uses an electric motor to drive certain operations of the machine. For example, the disclosed technology can be used with industrial machinery that uses one or more electric motors to drive hydraulic and/or mechanical operations of the machine (e.g., raising and/or lowering, extending and/or retracting, rotating, etc., components of the machine). Often, industrial machines need to start and stop operations frequently (e.g., to coordinate other machine operations, move to a different location, reposition, load material, deposit material, and the like). When machine operations stop (or pause), the electric motor can be configured to shut off automatically after a period of time to conserve energy and/or reduce wear of the motor. However, shutting off the electric motor can cause unwanted operational delays and operator dissatisfaction, due to having to restart the motor for subsequent operations.

The disclosed technology allows a machine with an electric motor to optimize automatic shut off timing of the electric motor so that the shut off delay is long enough to mitigate and/or prevent operational delay and dissatisfaction associated with having to restart the electric motor, but short enough to mitigate and/or prevent unnecessary energy waste and/or motor wear, on a dynamic (e.g., continuously-updating or changing) basis. For example, for a first job and/or set of tasks/assignments, the disclosed technology can anticipate frequent starting/stopping of the machine and increase the delay time for shut off of the electric motor to mitigate delay associated with corresponding frequent restarts of the motor. For a second job and/or set of tasks/assignments, the disclosed technology can anticipate relatively long periods of starting/stopping the machine and decrease the delay time to mitigate motor wear and wasting energy associated with running the motor when no motor action is imminent. The disclosed technology can continuously adjust and/or update the delay time during a given job and/or set of tasks/assignments based on one or more parameters (i.e., conditions, statuses, inputs) of the machine, one or more parameters of the electric motor, and/or one or more parameters of a user profile associated with the machine operator.

By dynamically adjusting the shut off delay time of the electric motor, a balance can be achieved between conserving energy and/or reducing unnecessary motor wear and mitigating operational delay and/or operator dissatisfaction due to having to restart the motor.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A system of optimizing electric motor shut off timing, the system comprising:
a machine including an electric motor, the electric motor configured to automatically shut off after a first period of time;
at least one hardware processor; and
at least one non-transitory memory storing instructions, which, when executed by the at least one hardware processor, cause the system to:
determine a pattern of values based on one or more parameters of the machine and/or one or more parameters of the electric motor, wherein the pattern of values is indicative of an action of the electric motor and/or machine;
generate a second period of time based on the pattern of values; and
automatically shut off the electric motor based on the second period of time.

2. The system of claim 1 wherein the pattern of values is based on one or more parameters of a user profile associated with an operator of the machine.

3. The system of claim 2 wherein the one or more parameters of the user profile includes at least one of: time since the operator previously shut off the electric motor, time since the operator previously started the electric motor, experience of the operator, certifications and/or qualifications of the operator, frequency of start up and/or shut off of the electric motor by the operator, and/or tasks assigned the operator.

4. The system of claim 1 wherein,
the one or more parameters of the machine includes: an action of the machine, status of the machine, input from an operator, movement of the machine, position of the machine, location of the machine, start up of the machine, shut off of the machine, run time of the machine, and/or tasks assigned the machine, and
the one or more parameters of the electric motor includes at least one of: run time of the electric motor, an action of the electric motor, status of the electric motor, and/or input from the operator.

5. The system of claim 1 wherein the pattern of values includes at least one of: time since previous shut off of the electric motor, time since previous start up of the electric motor, previous run time of the electric motor, frequency of start up and/or shut off of the electric motor, type of action of the electric motor, type of action of the machine, time since previous shut off of the machine, time since previous start up of the machine, previous run time of the machine, frequency of start up and/or shut off of the machine, likelihood of an action of the machine, and/or likelihood of an action of the electric motor.

6. The system of claim 1 wherein the pattern of values is determined via at least one machine-learning algorithm, wherein the at least one machine-learning algorithm is trained based on at least one dataset associated with previously determined patterns of values based on one or more parameters of the machine, one or more parameters of the electric motor, and/or one or more parameters of a user profile associated with an operator of the machine.

7. The system of claim 1, wherein the pattern of values is determined via one or more lookup tables.

8. The system of claim 1 wherein the at least one non-transitory memory further stores instructions, which, when executed by the at least one hardware processor, cause the system to determine a likelihood of an action of the electric motor based on the pattern of values, and wherein generating the second period of time is further based on the determined likelihood of the action.

9. The system of claim 8 wherein the at least one non-transitory memory further stores instructions, which, when executed by the at least one hardware processor, cause the system to determine a likelihood of an action of the machine based on the pattern of values, and wherein generating the second period of time is further based on the determined likelihood of the action.

10. The system of claim 1 wherein the one or more parameters are a first set of parameters and are indicative of a first action of the electric motor and/or machine, and wherein the at least one non-transitory memory further stores instructions, which, when executed by the at least one hardware processor, cause the system to:
correlate the first set of parameters with the first action of the electric motor and/or machine;
correlate a second set of parameters with a second action of the electric motor and/or machine; and
determine the pattern of values based on the first and second sets of parameters.

11. A method of optimizing electric motor shut off timing, the method comprising:
identifying a period of time associated with automatically shutting off an electric motor of a machine;
determining one or more parameters of the machine, the electric motor, and/or a user profile associated with an operator of the machine;
determining a pattern of values based on the one or more parameters, wherein the pattern of values is indicative of an action of the electric motor and/or machine;
modifying the period of time based on the pattern of values; and
automatically shutting off the electric motor based on the modified period of time.

12. The method of claim 11, further comprising analyzing, via at least one machine-learning algorithm, the pattern of values to generate a likelihood of an action of the electric motor, wherein modifying the period of time is further based on the likelihood of the action of the electric motor.

13. The method of claim 11, wherein the one or more parameters are a first set of parameters indicative of a first action of the electric motor and/or machine, and wherein the method further comprises:
correlating the first set of parameters with the first action of the electric motor and/or machine; and
correlating a second set of parameters with a second action of the electric motor and/or machine;
wherein determining the pattern of values is based on the first and second sets of parameters.

14. The method of claim 11 wherein,
the one or more parameters of the machine includes: an action of the machine, status of the machine, input from an operator, movement of the machine, position of the machine, location of the machine, start up of the machine, shut off of the machine, run time of the machine, and/or tasks assigned the machine, and
the one or more parameters of the electric motor includes at least one of: run time of the electric motor, an action of the electric motor, status of the electric motor, and/or input from the operator.

15. The method of claim 11 wherein the one or more parameters of the user profile includes at least one of: time since the operator previously shut off the electric motor, time since the operator previously started the electric motor, experience of the operator, certifications and/or qualifications of the operator, frequency of start up and/or shut off of the electric motor by the operator, and/or tasks assigned the operator.

16. A non-transitory, computer-readable storage medium comprising instructions recorded thereon, wherein the instructions, when executed by at least one data processor of a system, cause the system to:
determine a pattern of values based on one or more parameters of a machine and/or one or more parameters of an electric motor of the machine, wherein the electric motor is configured to automatically shut off after a period of time, and wherein the pattern of values is indicative of an action of the electric motor and/or machine;
modify the period of time based on the pattern of values; and
automatically shut off the electric motor based on the modified period of time.

17. The non-transitory computer-readable storage medium of claim 16 wherein,
the one or more parameters of the machine includes: an action of the machine, status of the machine, input from an operator, movement of the machine, position of the machine, location of the machine, start up of the machine, shut off of the machine, run time of the machine, and/or tasks assigned the machine, and
the one or more parameters of the electric motor includes at least one of: run time of the electric motor, an action of the electric motor, status of the electric motor, and/or input from the operator.

18. The non-transitory computer-readable storage medium of claim 16 wherein the pattern of values includes at least one of: time since previous shut off of the electric motor, time since previous start up of the electric motor, previous run time of the electric motor, frequency of start up and/or shut off of the electric motor, type of action of the electric motor, type of action of the machine, time since previous shut off of the machine, time since previous start up of the machine, previous run time of the machine, frequency of start up and/or shut off of the machine, likelihood of an action of the machine, and/or likelihood of an action of the electric motor.

19. The non-transitory computer-readable storage medium of claim 16 wherein the pattern of values is based on one or more parameters of a user profile associated with an operator of the machine.

20. The non-transitory computer-readable storage medium of claim 19 wherein the one or more parameters of the user profile includes at least one of: time since the operator previously shut off the electric motor, time since the operator previously started the electric motor, experience of the operator, certifications and/or qualifications of the operator, frequency of start up and/or shut off of the electric motor by the operator, and/or tasks assigned the operator.
